(19) United States
(12) Patent Application Publication
(10) Pub. No.: US 2026/0250611 A1
(43) Pub. Date: Aug. 27, 2026

(54) METHOD AND APPARATUS FOR RECOVERING ENERGY AND/OR SAVING ENERGY WHEN BREWING A BREWING LIQUID

(71) Applicant: GEA Brewery Systems GmbH, Kitzingen (DE)

(72) Inventor: Daniel HELLER, Kitzingen (DE)

(21) Appl. No.: 19/161,899

(22) PCT Filed: Mar. 4, 2024
(86) PCT No.: PCT/EP2024/055576

§ 371 Date: Sep. 3, 2025

(30) Foreign Application Priority Data
Mar. 6, 2023 (DE) 10 2023 105 424.4

(51) Int. Cl. C12C 7/22; C12C 7/17; C12C 13/08

(52) U.S. Cl. CPC C12C 7/22; C12C 7/17; C12C 13/08

(57) ABSTRACT

A method for recovering energy and/or saving energy when brewing a brewing liquid includes:
a) introducing a brewing liquid heated to a temperature T_{A} by a dephlegmator (20) into a wort kettle (W), the brewing liquid flowing at least through areas and/or sections of the dephlegmator (20); and
b) boiling, evaporating and/or vaporizing the brewing liquid in the wort kettle (W), the brewing liquid having a temperature T_{S}, and temperature T_{A} being no more than 30 K, preferably no more than 10 K, lower than temperature T_{S}; and
c) condensing the vapors produced during boiling, evaporation and/or vaporization of the brewing liquid in step b) into a fractionating column (D), which has at least one column tray (B), and the dephlegmator (20).

Furthermore, an apparatus (100) for recovering energy and/or saving energy when brewing a brewing liquid is provided.

The invention relates to a method and an apparatus for recovering energy and/or saving energy when brewing a brewing liquid according to the preamble of the independent claims.

The brewing of a brewing liquid, such as beer, an intermediate product in the production of beer and/or a product of fermentation, is an energy-intensive process, in which steam is preferably used for heating and boiling processes. Fossil fuels are predominantly burned to generate steam, which emits climate-damaging carbon dioxide. The state of the art knows various types of brewing apparatus for this purpose, such as internal boilers or external boilers in wort kettles, for example from published patent application DE 29 31 854 A1.

It is therefore not surprising that a large number of methods and apparatus are known from the prior art, in particular for reducing energy costs, which represent a substantial cost factor in brewing. For example, patent specification EP 1 769 062 B1 discloses a method for boiling wort using a fractionating column and a dephlegmator, in which the wort to be boiled is introduced into a wort kettle in batches and discontinuously and is boiled in the latter for a predetermined boiling time during a boiling phase at a boiling temperature essentially determined by the composition of the wort and the pressure conditions. On the steam side, the wort kettle is connected to a vertical column in which the wort vapor escaping during this boiling phase is subjected to fractionation in counterflow with the condensing vapor condensate. A cooling/heating circuit feeds the residual heat recovered in this process to other process steps occurring in the course of the brewing process.

The method for boiling wort described in patent specification EP 1 769 062 B1 does lead to a reduction in total vaporization and a shortening of the process time; however, the reduction in process time leads to an increase in the dimethyl sulfide (DMS) precursor DMSP in the finished wort due to a lack of thermal conversion. In addition, the use of water as an intermediate heat storage medium has the disadvantage of low efficiency due to multiple transfer losses and storage losses.

Patent specification EP 1 807 499 B1 describes a complete fractionated boiling process with separate vessels and separate treatment of the individual fractions, in which the lauter wort can be treated in different ways according to its different properties. However, the disadvantage here is that additional containers are required for fractionating the wort.

Furthermore, patent specification EP 2 190 971 B1 describes a method for flavor recovery using a fractionating column, in which the wort to be boiled can be introduced into the wort kettle either discontinuously or continuously. In this regard, a cooling unit at the end of the fractionating column for recovering residual heat is mentioned, which can be used in other brewing processes, for example. Another disadvantage of the method described is its low efficiency due to transfer losses and storage losses.

The prior art, such as European patent specification EP 0 751 985 B1, also discloses a fractionation process in the form of a stripping method. This involves continuously feeding wort into a fractionating column and stripping it in counterflow with steam. However, this method is completely continuous and therefore complex and not economical for small and medium-sized breweries. A similar fractionation process is known from European patent specification EP 0 873 395 B1. Here, the wort is finely distributed and treated in counterflow with steam or inert gas, which necessitates a complex additional vessel and an additional steam or gas supply to provide the stripping gas. This requires additional energy input.

Hence, there is a great need for a method and an apparatus for recovering energy and/or saving energy when brewing a brewing liquid in a brewery by means of which sufficient thermal conversion of the brewing liquid is possible in a simple, reliable, precise, and energy-optimized manner and an as-required removal of undesirable flavor substances is ensured. Furthermore, the method and the apparatus should achieve improved energy efficiency while shortening the process duration. In addition, the method and the apparatus should be cost-effective, reliable, individually adaptable to the conditions at the installation site, and retrofittable as required. Therefore, the object of the invention is to provide a method and an apparatus for recovering energy and/or saving energy when brewing a brewing liquid in a brewery in order to overcome the difficulties mentioned above and, above all, to reduce cleaning, maintenance and/or repair work to a minimum so as to thereby reduce the downtimes of the apparatus and the resulting costs to a minimum.

This object is attained in a surprisingly simple but effective manner by a method for recovering energy and/or saving energy when brewing a brewing liquid and a corresponding apparatus according to the teaching of the independent main claims.

According to the invention, a method for recovering energy and/or saving energy when brewing a brewing liquid is proposed, the method comprising the following steps:
a) introducing a brewing liquid heated to a temperature T_{A} by a dephlegmator into a wort kettle, the brewing liquid flowing at least through areas and/or sections of the dephlegmator; and
b) boiling, evaporating and/or vaporizing the brewing liquid in the wort kettle, the brewing liquid having a temperature T_{S}, and temperature T_{A} being no more than 30 K, preferably no more than 10 K, lower than temperature T_{S}; and
c) condensing the vapors produced during boiling, evaporation and/or vaporization of the brewing liquid in step b) at a fractionating column, which has at least one column tray, and at the dephlegmator.

The method according to the invention is based on the fundamental idea that indirect fractionation of the boiling and/or vaporization can be ensured by using a dephlegmator cooled with brewing liquid to be heated and by starting the wort boiling before the brewing liquid is completely pumped into the wort kettle. Since the brewing liquid, in particular the first wort, is added to the wort kettle earlier, it undergoes greater thermal conversion and expulsion of undesirable flavor substances than subsequent wort fractions. It has been found in this context that wort qualities which are the first to occur after lautering and require increased thermal conversion are thus thermally treated to a sufficient degree. Subsequent wort qualities require low thermal conversion and receive reduced thermal treatment through this method, which means that sufficient thermal conversion of the total brewing liquid can be ensured in this manner. In addition, the continuous boiling, evaporation and/or vaporization of the brewing liquid, the condensation of the vapors at the dephlegmator, and the fractionation including energy recovery within the process ensure that undesirable flavor substances are expelled sufficiently and as required.

Within the scope of the invention, it has also been found that the use of the dephlegmator ensures that all or most of the energy required for boiling, evaporation and/or vaporization of the brewing liquid is recovered and used directly for heating the brewing liquid in the same batch. In this way, total vaporization can be minimized with the method according to the invention, the efficiency of this method thus being significantly higher than that of comparable energy storage systems, especially since no intermediate storage medium is required. This is based on the finding that all rising vapors are condensed in the dephlegmator, and only when the dephlegmator is no longer cooled by the introduced brewing liquid is brewing liquid vaporized, which enters into the total vaporization. However, the previous fractionation has already expelled enough unwanted flavor substances from the brewing liquid and concentrated them in the fractionating column for the total vaporization to only account for the portion required to discharge these flavor substances from the column. Hence, wort boiling can begin even before the mash has been completely lautered. This results in an overall time saving in the brewing process. Ideally, the thermal treatment of the brewing liquid (wort boiling) can take place simultaneously or almost simultaneously with the end of wort production in the lautering system.

In the first step, a brewing liquid heated directly and immediately to a temperature T_{A} by a dephlegmator is introduced into a wort kettle, the introduction of the brewing liquid taking place continuously or discontinuously, preferably continuously. Due to the continuous introduction of the brewing liquid into the wort kettle with a fractionating column, the time during which the brewing liquid is preheated is extended, causing temperature T_{A} to be significantly higher. The brewing liquid is preheated by the dephlegmator of the fractionating column and simultaneously ensures a counterflow in the column. Within the scope of the invention, it has been found that the energy and heat input into the brewing liquid takes place directly and immediately, i.e., primarily, from the present method and/or process, which further contributes to an increase in temperature T_{A} due to the absence of transfer and/or intermediate storage losses as present in an energy storage system. In addition, it is essential that the brewing liquid evenly flows at least through areas and/or sections of the dephlegmator and that the dephlegmator is connected to the wort kettle in an energy- and/or heat-transferring manner using measures known to a person skilled in the art in such a manner that temperature T_{A} of the brewing liquid is essentially constant.

In the next step, the brewing liquid, such as wort or beer wort, flowing out of the lauter system or feed tank according to the state of the art is boiled, evaporated and/or vaporized at least partially or completely in order to inactivate enzymes, to coagulate the proteins contained therein, to isomerize the hop bitter substances, to adjust the original gravity, to evaporate undesirable flavor substances and/or to sterilize the brewing liquid in the wort kettle, the resulting total evaporation and/or vaporization being no more than 1.5 wt %, preferably no more than 1.4 wt %, 1.3 wt %, 1.2 wt %, 1.1 wt %, 1.0 wt %, 0.9 wt %, 0.8 wt %, 0.7 wt %, 0.6 wt %, 0.5 wt %, 0.4 wt %, 0.3 wt %, 0.2 wt % or 0.1 wt %. A person skilled in the art will understand that the brewing liquid in the wort kettle is preferably partially vaporized and/or evaporated. This vaporization/evaporation is the total evaporation and/or vaporization measurable to the outside. Due to the constant vaporization and condensation in the fractionation system, the internal vaporization is many times higher, which demonstrates the very good evaporation efficiency of the system. A person skilled in the art will understand the difference, in particular the relevant temperature difference, taking into account the pressure prevailing in the wort kettle and the composition of the brewing liquid, between boiling, i.e., the heating of a liquid to and at its boiling point, evaporation, i.e., the transition of liquid particles into the gas phase at temperatures below the boiling point of the liquid, and vaporization, i.e., the conversion of liquid particles into the gas phase by boiling. It has been found to be essential that the brewing liquid has a temperature T_{S} and that temperature T_{A} of the brewing liquid is no more than 30 K, preferably no more than 29 K, 28 K, 27 K, 26 K, 25 K, 24 K, 23 K, 22 K, 21 K, 20 K, 19 K, 18 K, 17 K, 16 K, 15 K, 14 K, 13 K, 12 K, 11 K, 10 K, 9 K, 8 K, 7 K, 6 K, 5 K, 4 K, 3 K, 2 K or 1 K, lower than temperature T_{S}. This means that exactly the quantity of heat and/or energy required to heat the brewing liquid flowing through the dephlegmator downstream is transferred by the rising vapor, which means temperature T_{S} essentially corresponds to temperature T_{A}. In addition, it has been found that the prolonged heating of the brewing liquid in step a) in the course of the process causes temperature T_{A} to be significantly higher, meaning the difference to temperature T_{S} is considerably lower than in the case of methods known from the prior art. This saves a considerable amount of energy costs, since the necessary energy has already performed a task, namely the thermal treatment of the brewing liquid in the wort kettle, and does not need to be stored temporarily. Furthermore, it is known to the person skilled in the art that temperature T_{S} depends on the pressure and the medium or the composition of the brewing liquid in the wort kettle and lies between 50° C. and 150° C., preferably between 70° C. and 120° C., and particularly preferably between 90° C. and 110° C.

The preferably lautered brewing liquid of a batch is therefore continuously introduced into the wort kettle, heated, boiled, partially evaporated and/or partially vaporized until all or at least the majority of the batch's brewing liquid to be boiled, vaporized and/or evaporated has been introduced (fed-batch), and as the brewing liquid first enters the wort kettle, it is boiled, partially evaporated and/or partially vaporized. This can already happen during the lautering process. As soon as sufficient counter-pressure has developed in the column by the vaporization of the wort, the continuous introduction of the wort at approximately boiling temperature directly into the fractionating column can take place; it is conceivable that this will result in the stripping of undesirable flavor components from the brewing liquid. Stripped flavor substances that have been vaporized and/or evaporated from the brewing liquid continuously accumulate in the fractionation section of the fractionating column. As soon as the entire batch of brewing liquid to be boiled, evaporated and/or vaporized has been introduced, or already during the introduction, the wort is pumped from the wort kettle into the fractionating column via a riser pipe. This can also cause stripping of the wort from unwanted flavor substances and flavor substances formed during boiling.

In the next step, the vapors produced during boiling, evaporation and/or vaporization of the brewing liquid in step b) are condensed at a fractionating column through which they are passed and at the dephlegmator. At the top of the column, a counterflow back into the fractionating column is created by (partial) condensation. The (partial) condensation takes place when the brewing liquid to be heated flows through the dephlegmator. When brewing liquid is used as a coolant, energy is recovered directly from the rising vapor. This increases the efficiency of energy recovery compared to a conventional energy concept with an energy storage tank. In addition, the undesirable flavor substances contained in the brewing liquid are reliably depleted as required and to a sufficient degree. When using brewing liquid to be heated as a coolant in the dephlegmator, the cooling effect is stopped at the end of the introduction of the brewing liquid to be boiled, evaporated and/or vaporized due to the lack of coolant. As soon as the cooling effect of the dephlegmator has been stopped, the vapors enriched with flavor substances are completely discharged from the column. It is also conceivable that another coolant (e.g., water) that is different from the brewing liquid additionally flows through the dephlegmator, which can then be used in other areas of the brewery. It is also conceivable that, for the condensation after the introduction of all brewing liquid, an additional installed condenser operated with a coolant other than brewing liquid can be used. It is also conceivable that, as soon as no more brewing liquid is available as a coolant, the method can be terminated and the liquid fraction on the uppermost tray, which contains enriched, expelled and/or stripped flavor components, can be discharged via a separate drain.

In the final step, the brewing of the brewing liquid is completed. A person skilled in the art will understand that not all of the brewing liquid is passed into the wort kettle, but that the last fractions can also be passed past the wort kettle, as detailed elsewhere.

The term “method for recovering energy and/or saving energy when brewing a brewing liquid” refers to an energy-efficient, energy-saving method for brewing a brewing liquid in a brewery that uses, in particular, existing heat, waste heat and/or energy from the method and/or the process directly and immediately for heating the brewing liquid, the energy saving and/or energy recovery being at least 30%, preferably at least 35%, 40%, 45%, 50%, 55%, 60%, 65%, 70%, 75%, 80%, 85% or 90%, based on the method known from the prior art and/or based on the total energy requirement of the method. It is also conceivable to additionally use waste heat and/or energy from renewable and/or regenerable energy sources. In addition, it is possible to track the conditions and/or influences under which the method was carried out. The method according to the invention may include additional steps which are performed after or between the explicitly listed essential steps a) to c). It is also conceivable that individual steps may be repeated as often as desired. The method is preferably automatable.

The term “fractionating column” is known to a person skilled in the art and refers to a process engineering apparatus for the thermal separation of mixtures, in which several distillation steps are connected in series, either discretely or continuously, by countercurrent flow of two phases, in particular a vapor phase and a liquid phase in direct contact with the vapor phase. The fractionating column has at least one, preferably 2, 3, 4, 5, 6, 7, 8, 9, 10 or more column trays of identical or different designs and is preferably disposed above and/or next to the word kettle, mounted on top of it and/or placed adjacent to it, with the result that low total vaporization is achieved and energy can be saved. It is also conceivable that the fractionating column can be retrofitted and designed as a single piece or in multiple pieces with the wort kettle and/or the dephlegmator. Known CIP systems can be used to clean the fractionating column. Spray heads in the fractionating column that are disposed in such a manner that all surfaces can be cleaned are particularly suitable. The trays in the fractionating column can be designed in various ways and can be selected from all known trays, such as sieve trays and bubble cap trays.

The term “dephlegmator” is known to a person skilled in the art and refers to a condenser that can condense steam/vapors and return them to the brewing liquid in the wort kettle. This distinguishes the dephlegmator from a classic kettle vapor condenser, which condenses vapors and discharges the condensate. As a result, the dephlegmator, in particular in combination with a fractionating column, achieves a higher separation efficiency and depletion of undesirable flavor substances with a low boiling point compared to water. The dephlegmator is connected to the fractionating column using measures familiar to a person skilled in the art and is preferably disposed above or at the upper end of the fractionating column. By using the dephlegmator with the brewing liquid to be heated as the cooling medium, the energy used can be transferred or recovered, the transfer of energy taking place within a brew or process and not between two brews or processes. Accordingly, the efficiency is also higher, as no intermediate storage of energy is required.

It is conceivable that the brewing liquid is preheated directly from the lauter tun via the dephlegmator, is boiled, evaporated and/or vaporized in the next step and is then introduced. The advantage would be the increased ΔT at the dephlegmator, which can therefore be of a smaller design. It is also conceivable to preheat the brewing liquid using a heating system first and then have the remaining increase in temperature to T_{A} take place via the dephlegmator. The disadvantage here would be the lower ΔT at the dephlegmator and a corresponding increase in the heat exchange surfaces. Introducing undercooled brewing liquid into the fractionating column would have the advantage of increased stripping efficiency. It is also conceivable to preheat the brewing liquid via the dephlegmator first and then effect the remaining increase in temperature to T_{A} using a heating system outside the wort kettle. The disadvantage here would be the increased technical complexity.

The term “undesirable flavor substances” is familiar to a person skilled in the art and refers to flavor substances introduced into the brewing liquid via malt. Due to the large number of undesirable flavor compounds, dimethyl sulfide (DMS) has become established as the key component for simplified orientation; it has been found that a sufficient depletion of DMS also causes the remaining undesirable flavor compounds to be depleted sufficiently and as required.

The method according to the invention enables indirect, fractionated wort boiling of the different qualities of the brewing liquid, allowing sufficient thermal conversion of the brewing liquid while ensuring that the undesirable flavor substances are expelled from the brewing liquid as required in a simple and reliable manner. The use of the dephlegmator, in which the brewing liquid is heated before it flows into the wort kettle, has the effect that the brewing liquid is introduced into the wort kettle continuously after lautering while the wort boiling is already in progress. This results in different thermal loads on the different wort qualities. This corresponds to indirect fractionated wort boiling. In addition, the amount of energy and heat available in the method is used directly and immediately to heat the brewing liquid to be introduced into the wort kettle, thus avoiding intermediate storage of energy and heat. This not only makes it possible to shorten the duration of the brewing process since wort boiling can already begin even if the lautering has not yet been completed but also improves energy efficiency. It is apparent to a person skilled in the art that the process duration is reduced in particular by the overlapping of pumping times and other process steps. In this way, the method according to the invention provides a means of decarbonizing breweries and makes a significant contribution to environmental protection. In addition, due to the simplicity, it is possible to drastically reduce the downtimes required for cleaning, maintenance and/or repair of the apparatus in order to avoid unnecessary downtimes and/or costs. Furthermore, it is possible to replace and/or repair only those elements affected by cleaning, maintenance and/or repair, thereby saving considerable costs.

Advantageous embodiments of the invention, which can be realized individually or in combination, are described in the dependent claims.

In one embodiment, it is conceivable that the method additionally comprises:
d) acquiring at least one current value of at least one characteristic physical, mechanical and/or chemical property of the brewing liquid, the wort kettle, the dephlegmator and/or the fractionating column in step a), b) and/or c), the characteristic property being selected from the temperature, the quantity, the filling level, the weight, the volume, the viscosity, the electrical conductivity, the flow rate, the volume flow, the pressure, the density, the duration, the time, the translucency, the light absorption, the color, the pH value, the chemical composition, and the concentration. Other properties not listed here are also conceivable.

Within the scope of the invention, it has been found that, for recovering energy and/or saving energy when brewing a brewing liquid in a brewery, it is sufficient to detect the change in at least one current value of at least one characteristic physical, mechanical and/or chemical property during the execution of the method. It is irrelevant which current value of the characteristic property is involved or whether it is determined directly or indirectly. For example, it is conceivable to determine the temperature in the feed pipe of the brewing liquid to be heated into the dephlegmator and/or in the discharge pipe of the brewing liquid heated to temperature T_{A} leaving the dephlegmator. It is also conceivable to determine the temperature of the brewing liquid in the fractionating column, in the dephlegmator and/or in the wort kettle. In addition, it is conceivable to determine the flow rate in a pipe, such as the feed and/or discharge pipe of the dephlegmator and/or an energy carrier, and/or in pumps. It is also conceivable to carry out a flow measurement and/or pressure measurement in the feed pipe of the energy carrier, in the feed pipe of the brewing liquid to be heated into the dephlegmator and/or in the discharge pipe of the brewing liquid leaving the dephlegmator. Moreover, the pressure can be determined in the wort kettle, in the fractionating column and/or in the dephlegmator.

The term “current value of at least one characteristic physical, mechanical and/or chemical property” refers to a property that is essential for the brewing liquid, the wort kettle, the dephlegmator and/or the fractionating column and other means involved in the method in steps a), b) and/or c) and by means of which a direct or indirect conclusion can be drawn about the property, the method and/or the progress of the method. For example, temperatures T_{A} and T_{S} are essential for ensuring that the brewing liquid is heated, boiled, evaporated and/or vaporized as required, as is temperature T_{S} of the brewing liquid for guaranteeing and ensuring that the brewing liquid meets the relevant legal and/or qualitative requirements, as described elsewhere. It is important that the current value is sufficiently accurately analyzed, known and/or defined, in particular its change over the duration of the process and time, preferably the progress of the method. The change can be represented, for example, but by no means exclusively, as a trend with a process progression and/or progress over time in a function, such as in a linear function, in a logarithmic function, in an exponential function, in a logistic function, in a polygonal function and/or in a mixture thereof. Within the scope of the invention, it is conceivable that step d) is repeated once, preferably twice, three times, four times, five times, six times, seven times, eight times, nine times, ten times, eleven times, twelve times, thirteen times, fourteen times, fifteen times or more frequently, under the same or different conditions.

It is also conceivable that the current value is acquired in combination with at least one further value for a factor which is related to the composition, the quantity and/or the volume of the brewing liquid, the temperature, the pressure, the place of use, the material, the size and/or the conditions of use of the means used to carry out the method, more preferably with values for 2, 3, 4, 5, 6, 7, 8, 9, 10, 11, 12, 13, 14, 15, 16, 17, 18, 19, 20 or more factors. This is because the current value depends on and/or can be influenced by various factors, the additional acquisition of which contributes to an improvement in the method for recovering energy and/or saving energy when brewing a brewing liquid in a brewery. In this context, for example, the humidity, the ambient pressure, the ambient temperature, the materials used and/or the brewing liquid are conceivable, which can affect the current value.

A person skilled in the art will understand that acquisition, identification and/or determination usually cannot be 100 percent accurate. The terms therefore refer to a statistically significant probability with regard to the accuracy of the acquisition, identification and/or determination of the current value or parameters, such as process parameters. Whether it is statistically significant can be determined by a person skilled in the art using methods known in the professional field without having to take an inventive step. Examples include statistical evaluation tools, such as the determination of the confidence interval, the p-value, the Student's t-test, the Mann-Whitney test, etc. The corresponding intervals are at least 90%, at least 95%, at least 97%, at least 98%, or at least 99% correct. The p-values are preferably 0.1, 0.05, 0.01, 0.005, or 0.0001. Preferably, the acquisition, identification and/or determination within the scope of the present invention is at least 60%, at least 70%, at least 80%, at least 90%, or at least 95% or at least 99% correct.

In one embodiment, it is conceivable that in step d), 2 to 20, preferably 3, 4, 5, 6, 7, 8, 9, 10, 11, 12, 13, 14, 15, 16, 17, 18, 19 or 20, identical or different current values of the same property or of multiple such properties are acquired. For example, it is conceivable that multiple identical or different current values are acquired. The acquisition of another current value or a further current value different therefrom offers the advantage that a better approximation of the functional relationship of the change thereof can be achieved. Here, the accuracy increases with the increasing number of current values acquired. A change can preferably be an improvement, a deterioration and/or a progression, in particular a temporal progression, thereof. It is conceivable that these values are taken into account, for example by repeating individual or multiple steps, as described elsewhere. This optimizes and significantly increases energy recovery and/or energy savings.

In yet another embodiment, it is conceivable that the method additionally comprises:
e) comparing the at least one current value acquired in step d) to a corresponding process parameter known to a person skilled in the art, a reference value and/or a subsequent other current value.

The term “process parameter” is known to a person skilled in the art and refers to a predefined, theoretical, set, calculated and/or manually obtained and/or empirically and/or manually assigned value of the temperature, the quantity, the filling level, the weight, the volume, the viscosity, the electrical conductivity, the flow rate, the volume flow, the pressure, the density, the duration, the time, the translucency, the light absorption, the color, the pH value, the chemical composition, and the concentration, which is stored for the process. It is conceivable that the process parameter or the value is a past value, a recipe value, an ideal value, an empirical value and/or a mixture thereof. It is also conceivable that the process parameter or value is unchangeable or changeable during the execution of the method, for example by adjustment to the temporal change of the current value described elsewhere.

The term “reference value” refers to a set, determined, predefined, theoretical, calculated and/or manually obtained, empirically and/or manually assigned, historically determined and/or legally prescribed framework condition that must be adhered to and is stored for the method and/or the process. The reference value, i.e., the framework condition to be adhered to, may in particular, but by no means exclusively, be a laboratory value, a database entry, a historical value, a recipe value, an ideal value, an empirical value and/or a mixture thereof and may be acquired before and/or at the start of the method and/or process. Furthermore, it is conceivable that the reference value defines a threshold value, which is preferably defined as the upper limit of the normal value of the current value under various conditions. The value of the upper limit of the normal value can be determined using various techniques that are well known to a person skilled in the art.

In this way, based on the previous comparison, it is possible to record the change in the current value, or even more preferably, the change in 2, 3, 4, 5, 6, 7, 8, 9, 10, 11, 12, 13, 14, 15, 16, 17, 18, 19, 20 or more, of the same or different current values and/or factors of the same property or multiple such properties.

The term “compare” refers to the comparison of current values to each other, in particular to a corresponding process parameter, a reference value and/or a subsequent other current value. It is understood that a comparison as used here refers to a comparison of corresponding parameters and/or values. For example, it is conceivable that an absolute value is comparable with another absolute value, whereas a relative value is comparable with another relative value.

Within the scope of the invention, the comparison can be carried out manually and/or with the assistance of a computer. For a computer-assisted comparison, all means known to a person skilled in the art are conceivable, such as a computer and/or a computer program. A computer program can additionally evaluate the result of the comparison, for example automatically provide an assessment of the acquired current values. It is also conceivable, for example, that step e) is supported by an assessment, analysis and/or evaluation unit. Preferably, the time of acquisition of the current value is taken into account in the comparison so that, based on the comparison, a prediction can be made as to how the value will change over time during the execution of the method. This offers the advantage that a temporal change in these values can be derived, identified, calculated computationally and/or manually and/or determined empirically and/or manually, so that the temporal change in these values can be stored and/or used as a process parameter or can influence a process parameter.

Within the scope of the invention, it is understandable that the result of the comparison depends directly or indirectly on the current value. It is therefore conceivable that a small and insignificant change, a large and significant change and/or no change in the current value in comparison to a corresponding process parameter, reference value and/or subsequent other current value is indicative of the execution and/or progression of the method. A change in the current value may preferably be an improvement, a deterioration and/or a progression, in particular a temporal progression, thereof. In this context, it is conceivable that the result of the comparison can be output as a time specification, for example in years, months, days, hours and/or minutes, as an absolute value and/or as a relative value.

In this context, it is also conceivable that the result of the comparison is an extension of the time specification of the method. In this manner, conclusions can be drawn, for example, about the change in the current value of the respective process as a function of the existing conditions. This offers the advantage that the condition influencing the current value can be determined and/or monitored.

Within the scope of the invention, it must be taken into account that all acquired and/or determined values and the result of the determination and/or the acquisition depend significantly on the materials and/or means used for the determination and/or the acquisition, the conditions of use of the means used to carry out the method and/or the place of use. This is known to a person skilled in the art.

It is also conceivable that the at least one current value, the other current value, the process parameter and/or the reference value are acquired under essentially similar conditions. This significantly increases the accuracy of the comparison in step e), in particular by partially or completely excluding various factors on which the at least one current value depends and/or which influence it, as described elsewhere.

The terms “essentially,” “essentially constant,” and “essentially similar” mean that there is only a minor, in particular insignificant, change, variation and/or deviation from the conditions in question. For example, it is conceivable that the change, variation and/or deviation from the condition prevailing for the implementation of the method is so minor that the method can still be implemented despite the change, variation and/or deviation. This means that this has no effect or an insignificant effect on the method.

It is also conceivable that the at least one current value, the other current value, the process parameter and/or the reference value are acquired under different conditions. Acquisition under different conditions, i.e., under conditions that differ from each other, makes it possible to determine the dependence of and/or the influence on the at least one current value on and/or by various factors, such as temperature, pressure, humidity, quantity, volume and/or chemical composition of the brewing liquid, size, material and/or design of the means used to carry out the method. This in turn has an influence on the efficiency of the method, for example by completely or partially avoiding or eliminating these factors.

In an embodiment, it is conceivable that the process parameter is selected from a value of the characteristic property that is stored, predefined, theoretical, set, calculated and/or obtained manually and/or assigned empirically and/or manually.

It is conceivable that the method additionally comprises:
f) displaying steps c), d) and/or e).

This variation makes it possible to numerically and/or graphically display the at least one current value acquired and/or compared in steps d) and/or e), individually or in comparison with each other or in comparison with others, in order to simplify understanding of the acquisition and/or comparison in this manner. It is also possible to display the condensation of the vapors produced during boiling, evaporation and/or vaporization in the fractionating column and the dephlegmator, for example as a percentage and/or as a quantity, and to display the capacity utilization of the fractionating column. A person skilled in the art is familiar with suitable means for displaying an output of a value. Step f) can be supported by an output unit.

Furthermore, it is conceivable that steps a), b), c), d), e) and/or f) are controlled and/or feedback-controlled, for example by means of a control and/or feedback control unit, in order to achieve simplification and/or automation of the method while making the best possible use of the amount of heat and energy available in the process. Suitable means are known to a person skilled in the art.

It is conceivable that a closed loop for heating the brewing liquid, introducing the heated brewing liquid into the wort kettle and/or the heating system is created, for example by means of the control and feedback control unit, in order to thus ensure the best possible utilization of the heat and/or energy available in the process during the cooling process of the dephlegmator. This offers the advantage that temperature T_{A} of the brewing liquid is as close as possible to, preferably essentially equal to, temperature T_{S} of the brewing liquid to be boiled, evaporated and/or vaporized. Furthermore, the method according to the invention, in particular steps a), b), c), d), e) and/or f), which are controlled and/or feedback-controlled by the closed loop, make it possible to determine the amount of heat and/or energy available in the process with sufficient accuracy in order to utilize it as completely as possible, preferably at least 90%, 91%, 92%, 93%, 94%, 95%, 96%, 97%, 98%, 99%, 99.5%, 99.9% or 100% of it, for heating the brewing liquid to temperature T_{A} in step a). In this manner, the amount of heat and/or energy required for boiling, evaporation and/or vaporization of the brewing liquid in step b) is reduced to a minimum.

The term “closed loop” is familiar to a person skilled in the art and refers to a dynamic interaction between the brewing liquid, the heating system, the dephlegmator, and the available amount of heat and/or energy in order to optimize the complete, if possible, utilization of the available heat and/or energy in the process. The closed loop is a closed system in which the actual values of the variables are continuously measured and compared with the target values of said variables. The negative feedback is essential here, as is known to a person skilled in the art.

In another embodiment, it is conceivable that the brewing liquid is divided into at least two, preferably more, fractions of equal and/or different sizes and/or that the brewing liquid is stripped. More preferably, some fractions may be of equal size, while others may also have a different size.

For the method according to the invention using the apparatus, in which
(i) the brewing liquid flows evenly through the dephlegmator,
(ii) the brewing liquid is partially vaporized when it first enters the wort kettle,
(iii) exactly the amount of energy required to heat the brewing liquid flowing through the dephlegmator downstream is transferred by the rising vapor,
(iv) the brewing liquid in the wort kettle is homogeneous, and
(v) the wort is divided into n equal fractions,
the following formulas (1) to (6) apply for an ideal system without radiation and/or transfer losses:

$${Q}_{L} = {Q}_{D} \qquad ( 1 )$$

$${Q}_{L} = {m}_{i + 1} \cdot {c}_{p} \cdot Δ T \qquad ( 2 )$$

$${Q}_{D} = {m}_{D} \cdot Δ {H}_{v} \qquad ( 3 )$$

$${m}_{{D}_{i}} = \frac{{m}_{D}}{i} \qquad ( 4 )$$

$${m}_{{D}_{i}} = \frac{{m}_{D}}{i} \qquad ( 5 )$$

$$\begin{matrix}{TE}_{i} [ \% ] = {\sum }_{i}^{n - 1} \frac{{m}_{{D}_{i}}}{{m}_{i}} = {\sum }_{i}^{n - 1} \frac{{m}_{i + 1} \cdot {c}_{p} \cdot Δ T}{Δ {H}_{V}} \cdot \frac{1}{{m}_{i}} \cdot \frac{1}{i} \cdot 100 \\ = {\sum }_{i}^{n - 1} \frac{{c}_{p} \cdot Δ T}{Δ {H}_{V}} \cdot \frac{1}{i} \cdot 100\end{matrix} \qquad ( 6 )$$

wherein
Q_{L} amount of energy to be absorbed by the wort coming from the lauter tun in order to heat it by ΔT
Q_{D} amount of energy to be released (at the dephlegmator) by the vapor rising in the fractionating column
cₚ specific heat capacity of the wort
ΔT temperature difference between the inlet and outlet temperatures of the wort in/from the dephlegmator
ΔHv vaporization enthalpy of the wort or of the water vaporized from the wort
mᵢ mass of the i-th fraction
m_{D} mass of the rising vapor in the fractionating column
m_{Di} Mass of the i-th fraction in the rising vapor in the fractionating column
TEᵢ theoretical thermal energy input into fraction i, expressed as a percentage of the vaporized mass of the i-th fraction over the period of wort inflow into the kettle relative to the total mass of the i-th fraction.

The term “fraction” is familiar to a person skilled in the art and refers to the division of the brewing liquid into at least two, preferably more, groups of equal and/or different sizes, which are introduced into the wort kettle individually and one after the other. It has been found to be essential that the highest thermal energy input occurs in the first fractions, i.e., in the first 0% to 30%, of the brewing liquid, while subsequent fractions have a significantly lower energy input. It is conceivable that a thermal energy input for boiling, evaporation and/or vaporization of the last fractions of the brewing liquid, i.e., the last 20% to 30%, can be dispensed with. Within the scope of the invention, it has also been found that dispensing with the heat and/or energy input for boiling, evaporation and/or vaporization into the last fractions of the brewing liquid results in a direct reduction and/or saving of the required amount of heat and/or energy by at least 10%, preferably at least 11%, 12%, 13%, 14%, 15%, 16%, 17%, 18%, 19%, 20%, 21%, 22%, 23%, 24%, 25%, 26%, 27%, 28%, 29%, 30% or more. The method according to the invention with fractionated boiling, evaporation and/or vaporization increases the thermal conversion of the brewing liquid, in particular of the first wort, which has the highest concentration of P-DMS, thereby achieving a reduction of P-DMS to DMS in the finished total wort.

The term “stripping” is known to a person skilled in the art and refers to the continuous introduction of the brewing liquid into the fractionating column, where it is exposed to a gaseous fluid, such as inert gas or hot steam, in countercurrent as it flows downward inside the column, leading to a separation of the substances contained in the brewing liquid. Due to the counterflow of hot steam to the liquid flowing downward, substances to be expelled (i.e., highly volatile components, e.g., DMS) pass from the fluid surface into the stripping steam until a phase equilibrium is preferably established.

Within the scope of the invention, it is conceivable that the brewing liquid can also be introduced into the fractionating column directly from the start and can be stripped in the process, provided that a suitable means known to a person skilled in the art is used to feed steam into the fractionating column directly below the point of introduction of the brewing liquid. The advantage here would be that all of the brewing liquid introduced would always be subject to stripping. In addition, no pipe for introduction at the bottom of the wort kettle and no additional heating device would be necessary, as heat is provided by the direct steam feed.

Furthermore, it is conceivable that the energy and/or heat required for the boiling, evaporation and/or vaporization of the brewing liquid in step b) could be obtained directly or indirectly from a heating process, from a waste heat process, in particular a waste heat process occurring in the brewery, and/or from renewable and/or regenerable energy sources by means of measures, means and/or methods known to a person skilled in the art.

It is also conceivable that the brewing liquid is wort, first wort, beer, beer wort, an intermediate product in the production of beer and/or a product of fermentation.

It is assumed that the definitions and/or explanations of the above terms apply to all aspects described hereinafter in this description unless otherwise specified.

The invention also proposes an apparatus for recovering energy and/or saving energy when brewing a brewing liquid, preferably for implementing the method described elsewhere, the apparatus comprising a wort kettle, a brewing liquid having a temperature T_{A} being introducible into the wort kettle, at least one heating system for boiling, evaporating and/or vaporizing the brewing liquid at a temperature T_{S} in the wort kettle, a fractionating column having at least one column tray, and a dephlegmator. The apparatus is characterized in that the brewing liquid flows at least through areas and/or sections of the dephlegmator and is heatable to temperature T_{A}, and that temperature T_{A} is no more than 30 K, preferably no more than 10 K, lower than temperature T_{S}.

The invention comprises at least one heating system, preferably 2, 3, 4, 5, 6, 7, 8, 9, 10 or more heating systems of the same or different designs, which are described in detail elsewhere and are necessary for boiling, evaporation and/or vaporization of the brewing liquid. It is conceivable that the brewing liquid flows at least through areas and/or sections of the heating system in order to optimize energy and/or heat transfer.

Advantageous embodiments of the invention, which can be realized individually or in combination, are described in the dependent claims.

It is conceivable that the apparatus comprises an energy store, a lautering system, a feed tank, a pump, at least one pipe, preferably multiple pipes, such as a feed pipe or a discharge pipe, a valve, a compressor, in particular a produced-vapor compressor for heat recovery from vapors/steam passing through the dephlegmator, a compressor device, a control and/or feedback control unit, an evaluation unit, an analyzing unit, an output unit, and/or at least one means for acquiring at least one current value of at least one characteristic physical, mechanical and/or chemical property of the apparatus and/or the brewing liquid, the characteristic property being selected from the temperature, the quantity, the filling level, the weight, the volume, the viscosity, the electrical conductivity, the flow rate, the volume flow, the pressure, the density, the duration, the time, the translucency, the light absorption, the color, the pH value, the chemical composition, and the concentration.

The term “evaluation unit” refers to a unit that is suitable for comparing the acquired current value to a corresponding process parameter, a reference value and/or a subsequent other current value. Suitable evaluation units, such as a computer and/or a computer program, are known to a person skilled in the art. A computer program can additionally assess the result of the comparison.

The term “evaluation unit” refers to a unit that is suitable for evaluating the comparison or for determining the amount of heat and/or energy required to heat the brewing liquid to temperature T_{A} and/or T_{S}. For example, the evaluation unit is a computer and/or a computer program.

The term “output unit” refers to a unit that is suitable for displaying the acquired and/or compared current values and the process parameters and the reference values, individually or in comparison with each other, the display preferably being numerical and/or graphical in order to simplify understanding of the acquisition and/or comparison in this manner. A suitable output unit for displaying, such as a directly or indirectly connected display and/or input device, in particular a computer, a monitor, a television set, a mobile device, and a smart mobile device, is known to a person skilled in the art.

The term “means for acquisition” refers to any means known to a person skilled in the art which is suitable for acquiring the current value of the apparatus and/or the brewing liquid, preferably at/under identical, successive or different times and/or conditions during the execution of the method. Preferably, the time and/or the conditions and/or factors present at that time, as mentioned elsewhere, are acquired simultaneously. Within the scope of the invention, at least one, preferably 2, 3, 4, 5, 6, 7, 8, 9, 10 or more, means of the same or different designs are conceivable.

The term “energy store” is known to a person skilled in the art and refers to a device for (interim) storage of energy and/or heat, which is filled with a storage medium, preferably water. Preferably, the energy store is a buffer storage, a pressure vessel and/or a stratified storage. The energy store makes it possible for waste heat available in the brewery and/or in another apparatus, such as in the dephlegmator, and/or the energy input from renewable energies, as described in detail elsewhere, to be made available to the apparatus equally or in a weighted manner. The waste heat process is preferably selected from another apparatus for brewing a brewing liquid, a heat pump, a heat exchanger, an air conditioning system, a refrigeration system, a compressed-air system, and a carbon dioxide recovery system. Preferably, the renewable energy source is selected from solar radiation, geothermal energy, wind power, hydropower, biogas, hydrogen, methanol, butane, natural gas and/or a mixture thereof. It is further preferred that several of the aforementioned means are coupled together; for example, a heat pump is coupled with at least one heat exchanger, preferably a condenser or a vaporizer. In this manner, the method is further improved with optimal utilization of the available energy and/or heat.

In an embodiment, it is conceivable that the heating system comprises an internal boiler, an external boiler, a heater, in particular an electric heater, an induction heater or a microwave, a heating surface, in particular in and/or on the word kettle, a bottom heater, a vaporizer, in particular a direct steam injection system, a direct firing system, a compressor, a compressor device, a heat pump, a heat exchanger, and/or a combination thereof. A person skilled in the art is familiar with the heating systems mentioned, their advantages and disadvantages, and their minimum filling levels. For instance, some heating systems are preferable especially with regard to a wort kettle that is partially filled with brewing liquid or with regard to the filling process during boiling, evaporation and/or vaporization. An external boiler or a heating surface makes more sense than other heating systems, for example. However, all heating systems are possible with the appropriate design. For instance, depending on the geometry of the internal boiler, an additional vaporization device is conceivable so that the brewing liquid can already be vaporized at the beginning. This can be, for example, direct steam injection and introduction of the brewing liquid into the column or an additional heating surface at the bottom of the wort kettle or a modified geometry of the internal boiler with introduction of the brewing liquid into the kettle. This is because existing internal boilers usually require complete coverage of their tube bundles/heating surfaces. This would mean that wort boiling can only begin once a large part of the wort is already in the wort kettle. With an external boiler, the brewing liquid can be introduced directly into the wort kettle or into the external boiler and can be vaporized there using the external boiler. Since it has been found in the context of the invention that the heat and/or energy is primarily introduced into the brewing liquid from the existing process, it is conceivable to design the heating system smaller, which saves considerable resources and costs. An additional advantage is the significantly lower volume flow of the brewing liquid when it is introduced into the wort kettle, as this reduces the energy density required. This also has a positive effect on the size of the heating system. Such means are known to a person skilled in the art and are suitable due to their efficiency.

In another embodiment, it is conceivable that the heating system directly or indirectly receives energy and/or heat from a battery, a rechargeable battery, an inverter, an energy store, a solar thermal power plant, a photovoltaic plant, a wind power plant, a water power plant, a geothermal power plant, a biogas plant, a fuel cell and/or a combination thereof. Since it has been found within the scope of the invention that energy and/or heat is introduced into the brewing liquid primarily from the present process, it is conceivable to supply the heating system from renewable heat sources. This creates an opportunity for decarbonizing breweries and significantly contributes to environmental protection. The renewable heat sources can be solar thermal energy, heat pumps, renewable electricity, waste heat from other processes, steam from biogas combustion or waste incineration, and other sources.

In another embodiment, it is conceivable that the at least one means of acquisition is a counter, an operating-time counter, a clock, an indicator, a thermometer, a camera, a camera system, a scale, a hygrometer, an ultrasonic device, a viscometer, a flow meter, a pressure probe, a tape measure, a sensor, in particular a nanosensor and/or microsensor, and/or a sensor system. In addition, other properties not listed here can be acquired using said means.

Examples of such means are known to a person skilled in the art. For instance, an “indicator” is characterized by the fact that it changes color when a predefined limit value, for example a pH value, a concentration, a chemical composition, or a temperature, is exceeded or not reached. The term “sensor” refers to a technical component known to the person skilled in the art which can detect certain physical, mechanical and/or chemical properties. The term “sensor system” refers to the use of sensors for measuring and/or monitoring changes in environmental, biological and/or technical systems.

For example, it is conceivable that the quantity, the filling level and/or the volume can be acquired directly using a filling level sensor or indirectly by means of a filling level gauge or a filling level estimation using a camera, a high-resolution camera system, a CCD sensor, a photodiode and/or a photocell. It is also conceivable that the translucency, the light absorption and/or the color of the brewing liquid is acquired using the camera, the high-resolution camera system, the CCD sensor, the photodiode and/or the photocell. In addition, it is possible, for example, to draw conclusions about the chemical composition of the brewing liquid from the change in the electrical resistance of an electrically conductive material. The temperature, in particular the temperature difference, can be acquired, for example, by means of a thermoelectric sensor, i.e., a thermocouple with or without an amplifier, a thermometer and/or an indicator. The weight, the quantity, the pressure and/or the volume of the brewing liquid, and, indirectly, the viscosity thereof, can be measured using a pressure sensor, a spring balance, a lifting scale and/or a manometer, for example. The viscosity can also be determined using a viscometer. The density can be measured using, for example, X-rays, ultrasound and/or irradiation with weak gamma rays, for example through the isotope method. The flow rate of the brewing liquid can be determined using a pressure probe, ultrasound, or Doppler radar, and the volume flow can be determined using flow meters. Furthermore, the chemical composition can be determined, for example by sampling, by means of near-infrared or infrared measurement, or can be derived from the aforementioned values. It is also conceivable that the duration, such as the process duration and/or the progression of the method and/or the time can be acquired and/or determined by means of a counter, an operating-time counter and/or a clock. In addition, the humidity in the wort kettle can be determined using a hygrometer and an indicator.

It is also conceivable that the brewing liquid is wort, first wort, beer, beer wort, an intermediate product in the production of beer and/or a product of fermentation.

Further details, features, and advantages of the invention are apparent from the following description of the preferred embodiments in conjunction with the dependent claims. The respective features may be realized individually or in combination with one another. The invention is not limited to the embodiments. The embodiments are shown schematically in the figures. Identical reference numbers in the individual figures denote identical or functionally identical elements or elements that correspond to each other in terms of their function.

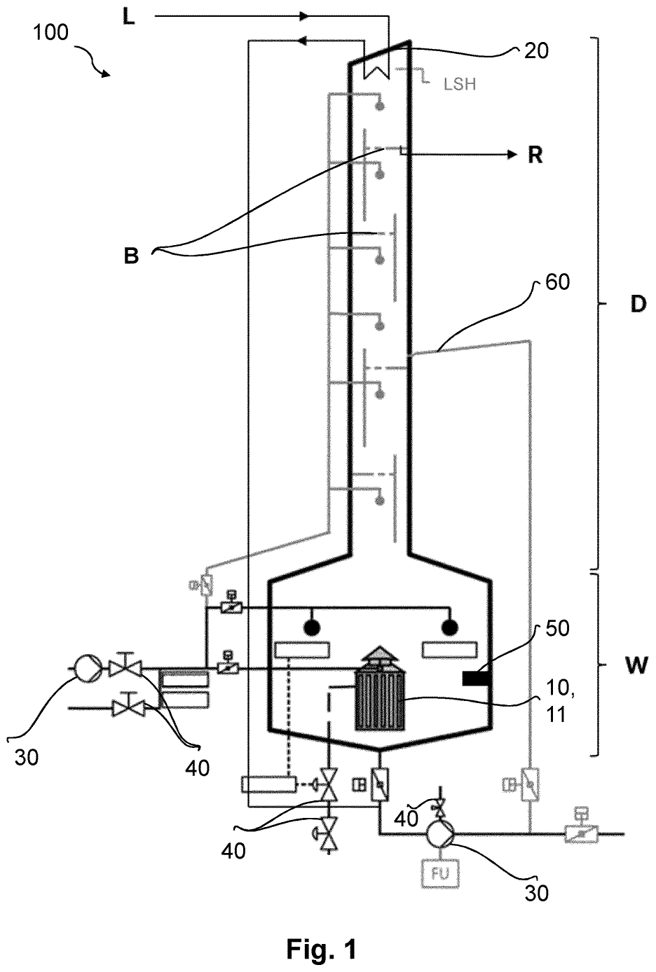

FIGS. 1 to 3 are schematic representations of an apparatus 100 according to the invention for implementing the method according to the invention; and

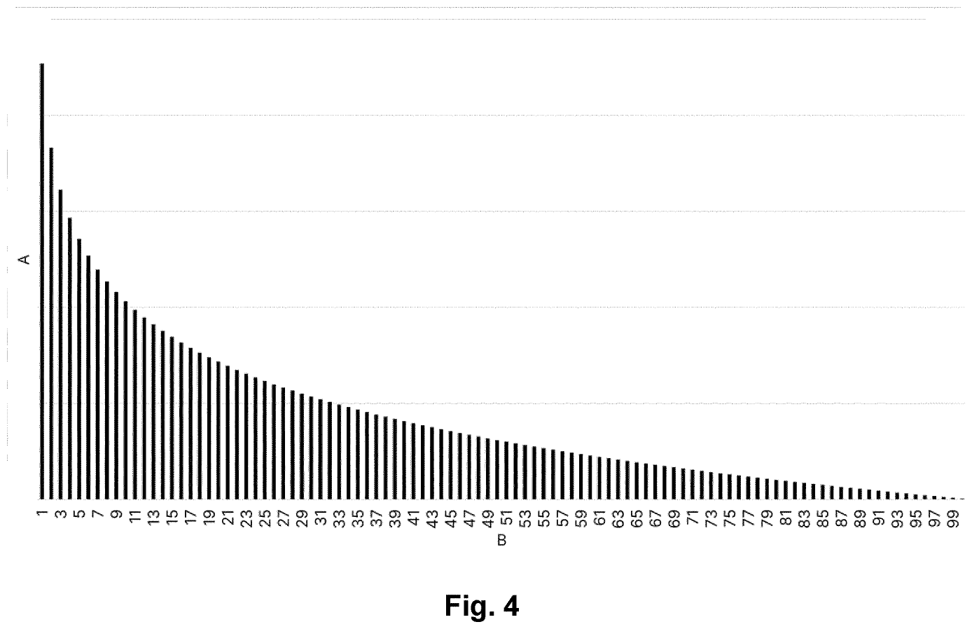

FIG. 4 is a diagram showing the thermal energy input of a 100-fraction word boiling process using the method according to the invention under ideal conditions; and

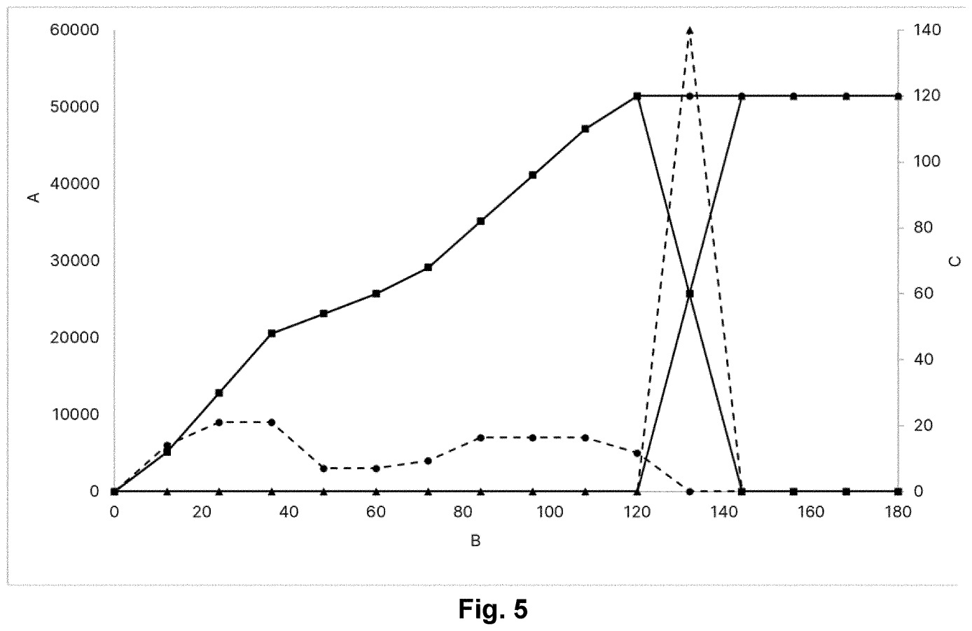

FIG. 5 is a diagram showing a comparison of volumes and volume flows between lautering with subsequent conventional boiling according to the prior art; and

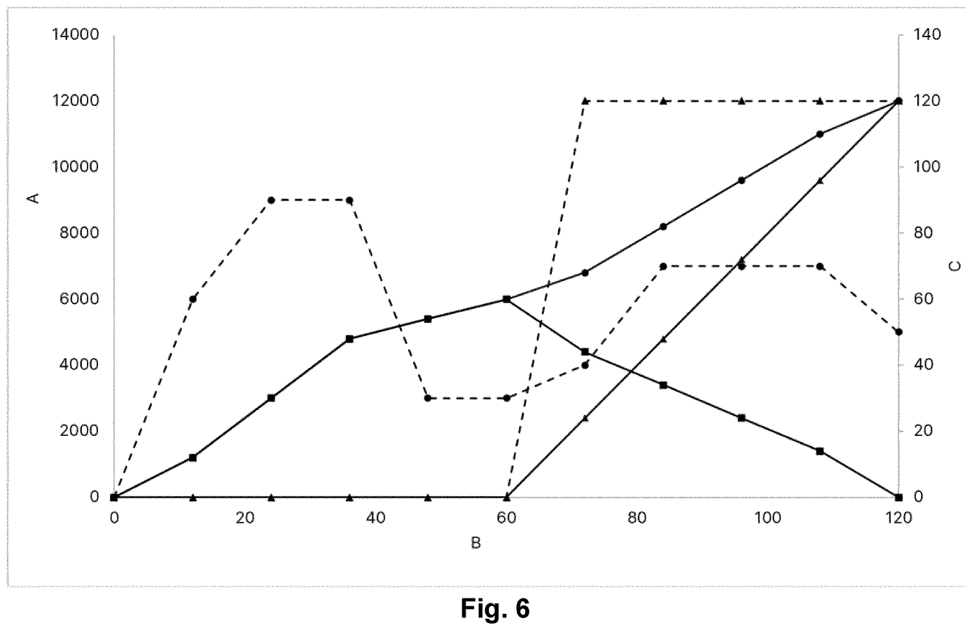

FIG. 6 is a diagram showing a comparison of volumes and volume flows between lautering with subsequent boiling according to the method according to the invention.

The apparatus 100 according to the invention for implementing the method according to the invention is shown as an example in FIG. 1 to FIG. 3 and has a wort kettle W with a brewing liquid (not shown), a heating system 10, 11, 12, a fractionating column D mounted on top of the wort kettle W, and a dephlegmator 20 at the upper end of the fractionating column D, the brewing liquid to be heated and/or boiled flowing through the dephlegmator 20.

The apparatus 100 according to the invention is shown in its simplest form in FIG. 1. As can be seen in FIG. 1, the brewing liquid from a lautering system or feed tank L is heated and introduced into the wort kettle W via the dephlegmator 20. In the wort kettle W, the brewing liquid is boiled, vaporized, and the vapors produced are introduced into the fractionating column D, which has four column trays B. The rising vapors heat the subsequent brewing liquid to be heated in the dephlegmator 20. At the same time, undesirable flavor components, such as dimethyl sulfide (DMS), are removed from the brewing liquid in this manner, as they accumulate in the fractionating column D. At the end of the wort boiling, these substances from the column trays B are discharged from the fractionating column D via the outlet R. Furthermore, one of the pipes of the apparatus 100 is designated as pipe 60, by means of which the brewing liquid can be introduced from the wort kettle to the column trays B of the fractionating column D.

During wort boiling, the amount of energy introduced into the wort kettle W for vaporization is the same as the amount of energy absorbed at the dephlegmator 20 for heating the wort. For this purpose, there is provided, in the preferred case, at least one means 50 for acquiring at least one characteristic physical, mechanical and/or chemical property of the apparatus 100 and at least one control and/or feedback control unit (not shown) which can detect, control and/or feedback-control the following elements:
flow measurement/control/feedback control in the feed pipe of the energy carrier (e.g., steam or hot water) for heating the brewing liquid in the wort kettle W, in the feed pipe of the brewing liquid to be heated leading into the dephlegmator 20, and/or in the pipe 60 of the brewing liquid leaving the dephlegmator 20,
pump control/feedback control of pumps 30 in the immediate periphery of the apparatus 100,
temperature measurement in the feed pipe of the brewing liquid to be heated and/or the brewing liquid leaving the dephlegmator 20, in the feed pipe of the energy carrier, and/or in the return pipe of the energy carrier, the brewing liquid, the wort kettle W and/or the fractionating column D,
pressure measurement in the feed pipe and/or in the return pipe of the energy carrier, the wort kettle W and/or the fractionating column D,
filling level measurement of the wort kettle W and/or the fractionating column D,
control and/or feedback control of valves 40 in the immediate periphery and within the apparatus 100.

Based on this, it is possible to control and/or feedback-control the wort boiling in the apparatus 100 in accordance with the examples shown in FIGS. 1 to 3 in such a manner that the advantages described elsewhere are achieved with the lowest possible energy requirement.

For example, the control and/or feedback control unit controls and/or feedback-controls the apparatus 100 according to the invention in such a manner that the flow rate of the brewing liquid through the dephlegmator 20 and/or the energy input into the wort kettle W is feedback-controlled on the basis of the temperature and the brewing liquid emerging from the dephlegmator 20.

For instance, the control and/or feedback control unit controls and/or feedback-controls the apparatus 100 according to the invention in such a manner that the quantity of energy introduced for vaporization or the quantity of steam for vaporization is feedback-controlled on the basis of the temperature of the brewing liquid and the flow rate of the brewing liquid through the dephlegmator 20 or by the pump speed of the pump 30 conveying the brewing liquid to be heated.

It is also conceivable, for example, that the control and/or feedback control unit feedback-controls the apparatus 100 according to the invention in such a manner that the pump speed and/or the flow rate of the brewing liquid to be heated through the dephlegmator 20 is controlled and/or feedback-controlled on the basis of the amount of energy/steam introduced for vaporization and the temperature of the brewing liquid to be heated. Other acquired current values of at least one characteristic physical, mechanical and/or chemical property of the apparatus 100 are conceivable, which are suitable for adjusting the energy input into the wort kettle W based on the amount of energy required to heat the wort at the dephlegmator 20.

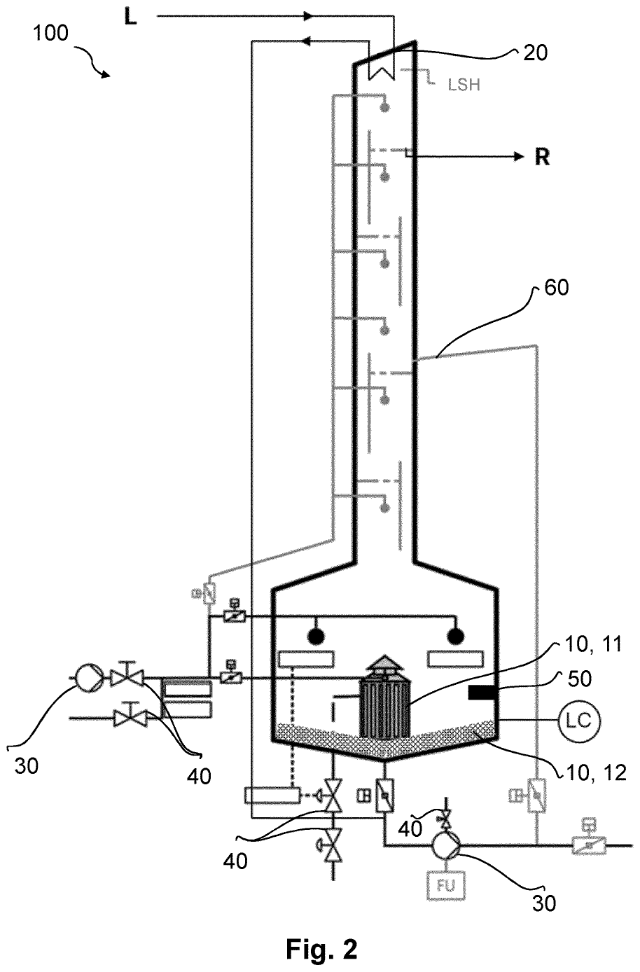

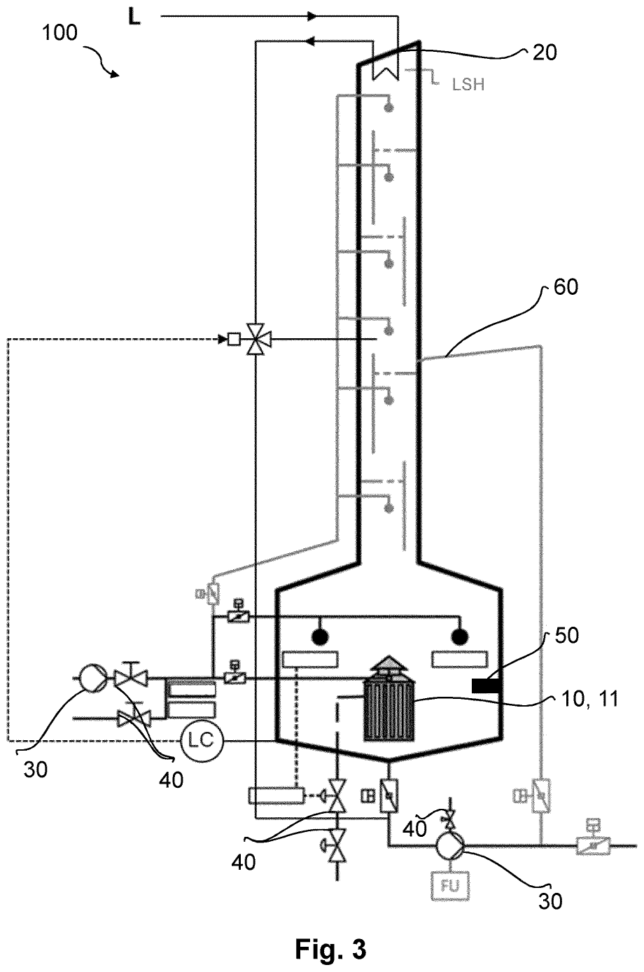

FIG. 2 shows that the apparatus 100 according to the invention has several heating systems 10, 11, 12. This may be relevant, for example, because each heating system 10, 11, 12 has different minimum filling levels of the brewing liquid in the wort kettle W. FIG. 2 shows an additional heating system in the wort kettle W as a bottom heater 12 (hatched area). In this regard, the control and/or feedback control unit controls the energy supply of the bottom heater 12 with electricity/steam until the first heating system 10, 11 can be used after the minimum filling level of the brewing liquid has been reached, which is detected by means of a filling level sensor. In addition, simultaneous use of several heating systems 10, 11, 12 with a corresponding control and/or feedback control unit, which distributes the required energy input into the wort kettle W among them, is also possible. FIG. 3 shows that the apparatus 100 according to the invention has an unlabeled three-way valve for direct introduction of the brewing liquid into the fractionating column D.

Furthermore, it is provided that the apparatus 100 according to the invention has a control and/or feedback control unit which is configured to switch the introduction of the brewing liquid between the wort kettle W and the fractionating column D or to divide the introduction of the brewing liquid into the wort kettle W and into the fractionating column D into volume portions of any size based on the acquired first current value of at least one characteristic physical, mechanical and/or chemical property and/or after a defined and/or preset time value has elapsed. For instance, it is provided that this be done by means of the filling level in the wort kettle W and/or the pressure in the fractionating column D. Furthermore, e.g., after reaching a predefined filling level and/or expiry of the time value, a transfer of brewing liquid from the wort kettle W into the fractionating column D via the pipe 60 can be controlled and/or feedback-controlled. This pumping step (stripping) can be carried out alone or simultaneously with the introduction of brewing liquid coming from the dephlegmator 20 via a valve 40, such as the unlabeled three-way valve; optionally, only part of the brewing liquid from the dephlegmator 20 is introduced into the fractionating column D at the valve and another portion continues to be introduced into the wort kettle W (see FIG. 3). When introducing the brewing liquid into the fractionating column D (stripping), the temperature of the brewing liquid is preferably either at the boiling point or slightly below the boiling point (≤5 K). A temperature slightly below the boiling point of the brewing liquid is advantageous because this allows the advantage of the lower boiling point of the highly volatile components (e.g., DMS) in comparison to the water content in the brewing liquid to be exploited, thus minimizing the vaporization of water from the introduced brewing liquid. Stripping generally has the advantage that, due to the counterflow of hot steam to the liquid flowing downward, substances to be expelled (i.e., highly volatile components, such as DMS) pass from the liquid into the stripping steam until a phase equilibrium is established. This further increases the effectiveness of the expulsion of undesirable flavor substances compared to a conventional method for cooking wort. To enhance and/or achieve the stripping effect, it is also possible to strip gas and/or direct steam into the system in addition to stripping with rising vapor from the brewing liquid. The introduction of gas/steam can also be used to expel oxygen or inert gas from the system before starting the process.

The apparatus 100 according to the invention can be operated either without pressure or with overpressure. The advantage of overpressure in the system would be a higher boiling temperature of the brewing liquid and thus also a higher temperature in the fractionating column D and at the dephlegmator 20 and a positive effect on the chemical conversion processes in the brewing liquid, such as hop isomerization and/or the conversion of DMS-P. Accordingly, the temperature difference between the rising vapor and the brewing liquid to be heated would also increase, which in turn would result in a more efficient heat transfer. However, in overpressure operation, care must be taken to ensure that the fractionating column Dis also completely under overpressure and that its upper end, in particular, is not directly connected to the atmosphere.

FIG. 4 shows an example of which theoretical thermal energy input TE for wort boiling with n=100 fractions and heating of the brewing liquid in the dephlegmator from 75° C. to 100° C. in the individual fractions results from formulas (1) to (6) described elsewhere. In FIG. 4, A describes the theoretical thermal energy input, expressed as a percentage of the vaporized mass of the fraction over the period of wort inflow into the wort kettle relative to the total mass of the fraction, and B describes the fractions [i].

As can be clearly seen in FIG. 4, the highest thermal energy input occurs in the first fractions of the brewing liquid, while subsequent fractions have a significantly lower energy input. Looking at the concentration of dissolved substances in the brewing liquid, said concentration decreases over the course of the lautering process. This is known to the person skilled in the art from a lautering diagram, which shows, among other things, the concentration curve of the extract. Consequently, in this boiling process, the wort fractions with the highest concentration of dissolved substances (e.g., DMS-P and proteins), and thus also the highest concentration of components to be expelled (e.g., DMS-P, formed from DMS), experience the highest energy input. Due to the fact that the concentration of dissolved substances in the brewing liquid decreases over the lautering time, thermal energy input for the vaporization of the last fractions can be dispensed with without any loss of quality, as the concentration of components to be expelled is small to negligible there, too. Example: Dispensing with the energy input for vaporization into the fractions that make up the last 20 to 30% of the brewing liquid results in a direct reduction/saving of the amount of energy needed by 20 to 30%. At the same time, these fractions can be used to pre-cool the total wort without thermal energy input for vaporization, thus replacing classic wort pre-cooling. For example, this last fraction can be introduced into the downstream vessel, usually a whirlpool (not shown), or added to the remaining brewing liquid on its way there. It is also conceivable to add it to the wort kettle at the end of the thermal treatment.

The direct transfer of energy from the vaporized brewing liquid to the brewing liquid to be heated by means of the dephlegmator reduces transmission losses by 50% compared to conventional energy storage or energy recovery systems for wort boiling. Furthermore, all radiation losses from an energy storage tank and pipe losses are eliminated, as the direct transfer of energy means that no intermediate storage is necessary, as is the case with conventional energy recovery systems. By dispensing with energy storage water as an intermediate medium, all energy required to transport this water, such as electrical energy for pumps, is also eliminated. This results in a total reduction in energy losses of 50% to 80% and a reduction in the electrical energy input of up to 90% in relation to energy recovery systems.

Using the method according to the invention, the wort boiling can already start while the lautering of the brewing liquid is still in progress and can end at the same time (≤5 min) as the lautering. The comparison of volumes and volume flows between lautering with subsequent conventional boiling is shown in FIG. 5, and the comparison of lautering with subsequent boiling according to the method of the invention is shown in FIG. 6. In FIGS. 5 and 6, A is the volume flow in L/h, B is the time in min, C is the volume in h1, the point with a solid line=total volume of lautered brewing liquid, the point with a dashed line=volume flow of lautered brewing liquid from the lauter tun to the feed tank, the triangle with the solid line=volume of brewing liquid in the wort kettle, the triangle with the dashed line=volume flow of lautered brewing liquid in the wort kettle from the feed tank, and the square with the solid line=volume of brewing liquid in the feed tank. In FIG. 5, the volume of the brewing liquid in the feed tank until the start of pumping into the wort kettle is equal to the total volume of the lautered brewing liquid.

Since boiling in the present invention already starts before all of the brewing liquid of the brew is in the wort kettle, the total occupancy time of the wort kettle is reduced compared to conventional systems. The time normally required for pumping the brewing liquid into the wort kettle overlaps with the wort boiling time in this method. This eliminates up to 80% of the time required for pumping or the time between the end of the lautering/the feed tank being full and the wort kettle being full in the conventional method.

The described potential of this method in terms of eliminating the need for thermal treatment of the last fractions of the wort (20 to 30% of the total wort) further reduces the system's occupancy time per brew. Since the last fractions do not have to be treated in the wort kettle, they can be introduced directly into the whirlpool or to the next process step after wort boiling. This reduces the time required for the brewing liquid to settle by the same percentage as the proportion of the untreated brewing liquid (20 to 30%).

1. A method for recovering energy or saving energy when brewing a brewing liquid, the method comprising the following steps:
a) introducing a brewing liquid heated to a temperature T_{A} by a dephlegmator (20) into a wort kettle (W), the brewing liquid flowing at least through areas or sections of the dephlegmator (20); and
b) boiling, evaporating or vaporizing the brewing liquid in the wort kettle (W), the brewing liquid having a temperature T_{S}, and temperature T_{A} being no more than 30 K lower than temperature T_{S}; and
c) condensing the vapors produced during boiling, evaporation or vaporization of the brewing liquid in step b) into a fractionating column (D), which has at least one column tray (B), and the dephlegmator (20).

2. The method according to claim 1, wherein the method additionally comprises:
d) acquiring at least one current value of at least one characteristic physical, mechanical or chemical property of the brewing liquid, the wort kettle (W), the dephlegmator (20) or the fractionating column (D) in step a), b) or c), the characteristic property being selected from the temperature, the quantity, the filling level, the weight, the volume, the viscosity, the electrical conductivity, the flow rate, the volume flow, the pressure, the density, the duration, the time, the translucency, the light absorption, the color, the pH value, the chemical composition, and the concentration.

3. The method according to claim 2, wherein, in step d), 2 to 20 identical or different current values are acquired.

4. The method according to claim 2, wherein the method additionally comprises:
e) comparing the at least one current value acquired in step d) to a corresponding process parameter, a reference value or a subsequent other current value.

5. The method according to claim 4, wherein the at least one current value, the other current value, the process parameter or the reference value are acquired under essentially similar conditions.

6. The method according to claim 4, wherein the at least one current value, the other current value, the process parameter or the reference value are acquired under different conditions.

7. The method according to claim 4, wherein the process parameter is selected from a value of the characteristic property that is stored, predefined, theoretical, set, calculated or obtained manually or assigned empirically or manually.

8. The method according to claim 1, wherein the method additionally comprises:
f) displaying the steps c), d) or e).

9. The method according to claim 1, wherein step(s) a), b), c), d), e) or f) is/are controlled or feedback-controlled.

10. The method according to claim 1, wherein the brewing liquid is separated into at least two fractions or the brewing liquid is stripped.

11. The method according to claim 1, wherein the energy or heat required for boiling, evaporating or vaporizing the brewing liquid in step b) stems from a heating process, from a waste-heat process or from renewable or regenerable energy sources.

12. The method according to claim 1, wherein the brewing liquid is wort, first wort, beer, beer wort, an intermediate product in the production of beer or a product of fermentation.

13. An apparatus (100) for recovering energy or saving energy when brewing a brewing liquid, for implementing the method according to claim 1, the apparatus comprising a wort kettle (W), a brewing liquid having a temperature T_{A} being introducible into the wort kettle (W), at least one heating system (10, 11, 12) for boiling, evaporating or vaporizing the brewing liquid at a temperature T_{S} in the wort kettle (W), a fractionating column (D) having at least one column tray (B), and a dephlegmator (20),
wherein:
the brewing liquid flows at least through areas or sections of the dephlegmator (20) and is heatable to temperature T_{A}, and that temperature T_{A} is no more than 30 K lower than temperature T_{S}.

14. The apparatus (100) according to claim 13,
wherein:
the apparatus (100) comprises an energy store, a lautering system, a feed tank (L), a pump (30), a pipe (60), a valve (40), a compressor, a compressor device, a control or feedback control unit, an evaluation unit, an analyzing unit, an output unit, or at least one means (50) for acquiring at least one current value of at least one characteristic physical, mechanical or chemical property of the apparatus (100) or the brewing liquid, the characteristic property being selected from the temperature, the quantity, the filling level, the weight, the volume, the viscosity, the electrical conductivity, the flow rate, the volume flow, the pressure, the density, the duration, the time, the translucency, the light absorption, the color, the pH value, the chemical composition, and the concentration.

15. The apparatus (100) according to claim 13,
wherein:
the heating system (10, 11, 12) is an internal boiler, an external boiler, a heater, an electric heater, a heating surface, a bottom heater (12), a vaporizer (11), a direct firing system, a compressor, a compressor device, a heat pump, a heat exchanger, or a combination thereof.

16. The apparatus (100) according to claim 13,
wherein:
the heating system (10, 11, 12) directly or indirectly receives energy or heat from a battery, a rechargeable battery, an inverter, an energy store, a solar thermal power plant, a photovoltaic plant, a wind power plant, a water power plant, a geothermal power plant, a biogas plant, a fuel cell or a combination thereof.

17. The apparatus (100) according to claim 14,
wherein:
the at least one means (50) of acquisition is a counter, an operating-time counter, a clock, an indicator, a thermometer, a camera, a camera system, a scale, a hygrometer, an ultrasonic device, a viscometer, a flow meter, a pressure probe, a tape measure, a sensor, a sensor system, or a combination thereof.

18. The apparatus (100) according to claim 13,
wherein:
the brewing liquid is wort, first wort, beer, beer wort, an intermediate product in the production of beer, or a product of fermentation.
